(19) United States
(12) Patent Application Publication
(10) Pub. No.: US 2016/0137308 A1
(43) Pub. Date: May 19, 2016

(54) RAM AIR TURBINE WITH COMPOSITE SHAFT

(71) Applicant: Hamilton Sundstrand Corporation, Charlotte, NC (US)

(72) Inventors: Michael E. Larson, Rockford, IL (US); David N. Chapman, Rockford, IL (US)

(21) Appl. No.: 14/543,080

(22) Filed: Nov. 17, 2014

(51) Int. Cl. B64D 41/00

(52) U.S. Cl. CPC B64D 41/007

(57) ABSTRACT

A ram air turbine includes a strut. The strut includes a turbine portion and an opposed vehicle connection portion. The ram air turbine also includes a turbine operatively connected to the turbine portion of the strut to rotate relative to the strut. A shaft is disposed within the strut. The strut includes a turbine end and a vehicle connection end. The turbine end is operatively connected to be driven by the turbine to rotate within the strut. The shaft includes a composite material that has a tuned performance for at least one of optimal critical speed, bending, torsional stiffnesses, and/or resonant frequencies over an operational speed envelope of the shaft.

### BACKGROUND

1. Field

The present disclosure relates to ram air turbines, more specifically to ram air turbines for vehicle emergency power generation.

2. Description of Related Art

The primary function of a ram air turbine (RAT) is to provide electrical and/or hydraulic power to the aircraft at any flight phase during the aircraft's operational profile during emergency situations where other electrical generation sources are non-functional. Depending on the specific RAT configuration and size, e.g., if it has a gearbox, and/or an electric generator, and/or a hydraulic pump, or combinations thereof, a strut drive shaft of significant length may be required. Such a drive shaft is typically housed inside the RAT strut and connects the gearbox of the turbine to another upper gearbox, a generator, and/or pump.

Conventionally, the drive shaft has been constructed of steel. This typically results in an over designed shaft in order to meet all required performance parameters such as bending and torsional stiffness. This results in a shaft that is heavier and larger than what would be needed if each of the performance parameters could be independently addressed.

Such conventional methods and systems have generally been considered satisfactory for their intended purpose. However, there is still a need in the art for improved ram air turbines. The present disclosure provides a solution for this need.

### SUMMARY

A ram air turbine includes a strut. The strut includes a turbine portion and an opposed vehicle connection portion. The ram air turbine also includes a turbine operatively connected to the turbine portion of the strut to rotate relative to the strut. A shaft is disposed within the strut. The strut includes a turbine end and a vehicle connection end. The turbine end is operatively connected to be driven by the turbine to rotate within the strut. The shaft includes a composite material that has a tuned performance for at least one of optimal critical speed, bending, torsional stiffnesses, and/or resonant frequencies over an operational speed envelope of the shaft.

For example, the composite material of the shaft can be anisotropic and can be tuned for bending and torsion while minimizing weight and diameter. The composite material of the shaft can be a wound composite including a fiber count, a winding direction, and a winding pitch. The shaft can be hollow. At least one of the fiber count, the winding direction, and the winding pitch can be selected to achieve the tuned performance.

The shaft can include metal fittings mounted at each end thereof. The turbine end of the shaft can be indirectly connected to the turbine through a lower gear box. The vehicle connection end can be connectable to one or more of a generator, an upper gear box, or a pump.

The vehicle connection portion of the strut can be moveably attachable to a vehicle to deploy from the vehicle e.g., by rotation. For example, the vehicle can be an aircraft.

In at least one aspect of this disclosure, an aircraft includes an emergency ram air turbine generator as described herein, wherein the emergency ram air turbine generator deploys upon failure of one or more electrical generators on board the aircraft.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a cross-sectional, elevated side view of an embodiment of a ram air turbine in accordance with this disclosure, showing a composite shaft connecting a generator to a turbine;

FIG. 2 is a partial cross-sectional of the composite shaft of FIG. 1; and

FIG. 3 is a partial perspective cutaway of the composite shaft of FIG. 2.

### DETAILED DESCRIPTION

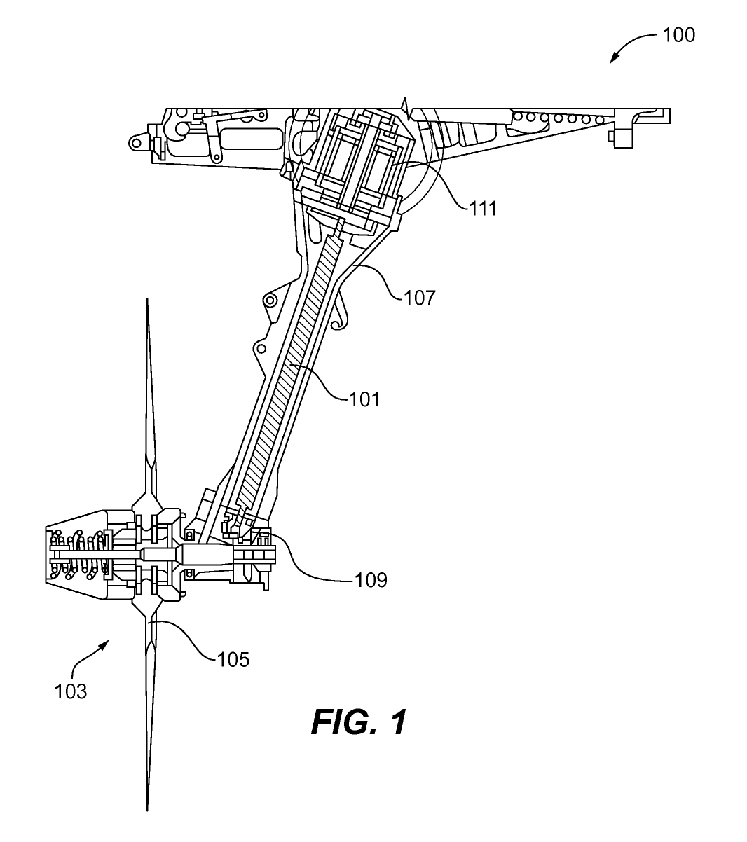

Reference will now be made to the drawings wherein like reference numerals identify similar structural features or aspects of the subject disclosure. For purposes of explanation and illustration, and not limitation, an illustrative view of an embodiment of a ram air turbine in accordance with the disclosure is shown in FIG. 1 and is designated generally by reference character 100. The systems and methods described herein can be used to reduce weight and enhance performance relative to traditional emergency ram air turbines for vehicles such as aircraft.

In at least one aspect of this disclosure, referring to FIG. 1, a ram air turbine 100 includes a strut 107 operatively connectable to a vehicle (not shown) to deploy from the vehicle. The strut 107 includes a turbine portion 103 and a vehicle connection portion 111 for attaching to a vehicle. The strut 107 can be made of any suitable material (e.g., aluminum, plastic, composites).

The vehicle connection portion 111 of the strut 107 can be moveably attachable to a vehicle to deploy from the vehicle. The vehicle connection portion 111 of the strut 107 can be rotatably attached to a vehicle, e.g., for deployment from the vehicle for power generation. For example, the vehicle can be an aircraft utilizing the ram air turbine 100 for power generation in emergencies.

The ram air turbine 100 also includes a turbine 105 operatively connected via a lower gearbox to the strut 107 at the turbine portion 103 of the strut 107 to rotate relative to the strut 107. The turbine 105 can include a bladed propeller or any other suitable device configured to rotate due to passing airflow. This rotational energy can, in turn, drive an electrical generator, pump, or the like to provide emergency electrical power or pressurization.

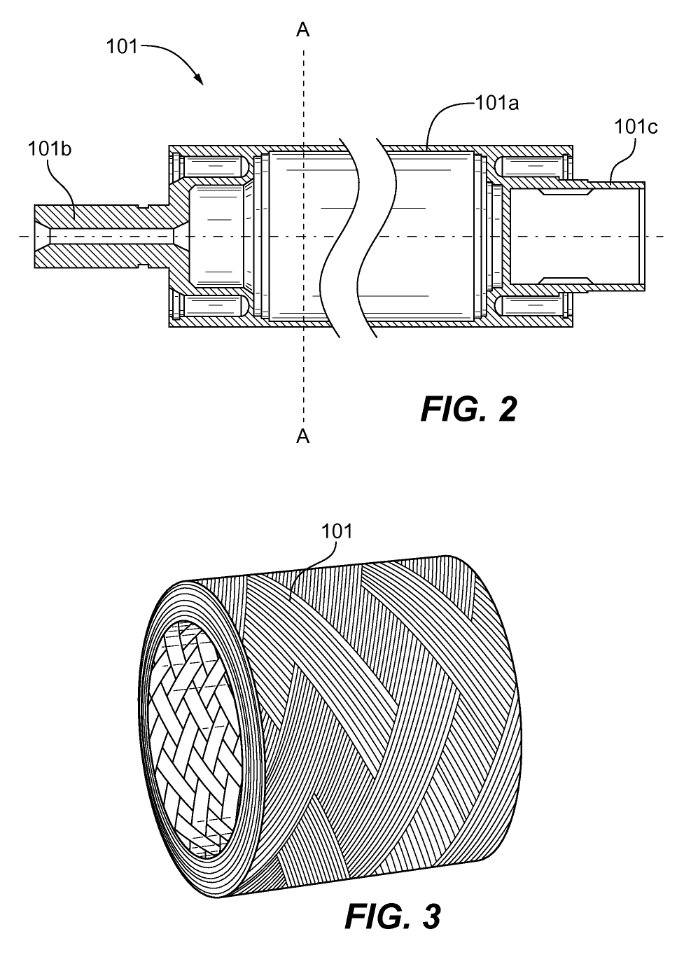

Referring additionally to FIGS. 2 and 3, a shaft 101 is disposed within the strut 107 and defines a shaft body 101a, turbine end 101b, and a vehicle connection end 101c. The turbine end 101b is operatively connected to the turbine 105 to rotate with the turbine 105 and within the strut 107. The shaft 101 includes a composite material that has a tuned performance for at least one of optimal critical speed, bending, torsional stiffnesses, and/or resonant frequencies over an operational speed envelope of the shaft 101.

Referring to FIG. 3, the composite material of the shaft 101 can be a wound composite including a fiber count, a winding direction, a winding pitch, a thickness, and a diameter. As shown, the shaft 101 can be hollow. The fiber can be carbon fiber wound on a mandrel and adhered together with epoxy resin or the like.

At least one of the fiber count, the winding direction, the winding pitch, the thickness, and the diameter can be selected to achieve the tuned performance. This anisotropic configuration allows for tunability to achieve specific shaft bending and torsional stiffnesses as well as critical speed. This cannot be achieved using materials with isotropic material properties such as steel. Therefore, the ram air turbine shafts 101 as described herein can provide sufficient strength and performance characteristics (e.g., bending and torsion modes), with substantially less weight than traditional ram air turbines.

The shaft 101 can include metal fittings at each end 101b, 101c thereof such that the ends are made of metal and attached to the shaft body 101a. The metal fittings can be attached to strengthen each ends 101b, 101c for coupling to, for example, a gear box 109 or generator. The coupling of the metallic ends to the composite material can be achieved by riveting, adhesive, special fit, a combination thereof, or any other suitable means.

The turbine end 101b of the shaft 107 can be indirectly connected to the turbine 105 through a lower gear box 109. The vehicle connection end 101c can be connectable to one or more of a generator, an upper gear box connected to a generator, and/or a pump. The generator is connected to the electrical system, and the pump to the hydraulic system, of the vehicle. Any other suitable mechanical connection is contemplated herein.

In at least one aspect of this disclosure, an aircraft (not shown) includes an emergency ram air turbine generator having a ram air turbine 100 as described above. The emergency ram air turbine generator deploys upon failure of one or more electrical generators on board the aircraft. For example, if all powerplants on the aircraft fail, the emergency ram air turbine generator deploys and provides electricity to the aircraft electrical system or components thereof in order to maintain critical systems for flight, navigation, and communication.

The methods and systems of the present disclosure, as described above and shown in the drawings, provide for composite shafts for ram air turbines with superior properties including reduced weight and enhanced performance compared to traditional shafts. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A ram air turbine, comprising:
a strut including a turbine portion and a vehicle connection portion;
a turbine operatively connected to the strut at the turbine portion of the strut to rotate relative to the strut; and
a shaft disposed within the strut and defining a turbine end and a vehicle connection end, the turbine end operatively connected to the turbine to be driven by the turbine within the strut, wherein the shaft includes a composite material that has a tuned performance for at least one of optimal critical speed, bending, torsional stiffnesses, and/or resonant frequencies over an operational speed envelope of the shaft.

2. The ram air turbine of claim 1, wherein the composite material of the shaft is wound composite including a fiber count, a winding direction, a winding pitch, a thickness, and a diameter.

3. The ram air turbine of claim 1, wherein the composite material of the shaft is anisotropic.

4. The ram air turbine of claim 2, wherein at least one of the fiber count, the winding direction, the winding pitch, the thickness, and the diameter is selected to achieve the tuned performance.

5. The ram air turbine of claim 4, wherein the shaft includes metal fittings mounted at each end thereof.

6. The ram air turbine of claim 5, wherein the turbine end of the shaft is indirectly connected to the turbine through a gear box.

7. The ram air turbine of claim 6, wherein the vehicle connection end is connectable to one or more of a generator, a gear box, or a pump.

8. The ram air turbine of claim 7, wherein the composite material of the shaft is tuned for bending and torsion modes while minimizing weight.

9. The ram air turbine of claim 8, wherein the vehicle connection portion of the strut is rotatably attachable to a vehicle to deploy from the vehicle.

10. The ram air turbine of claim 9, wherein the vehicle is an aircraft.

11. An aircraft emergency power system, comprising:
an emergency ram air turbine generator including:
a strut operatively connectable to a vehicle to deploy from the vehicle, the strut including a turbine portion and a vehicle connection portion;
a turbine operatively connected to the strut at the turbine portion of the strut to rotate relative to the strut; and
a shaft disposed within the strut and defining a turbine end and a vehicle connection end, the turbine end operatively connected to the turbine to rotate with the turbine and within the strut, wherein the shaft includes a composite material that has a tuned performance for at least one of optimal critical speed, bending, torsional stiffnesses, and/or resonant frequencies over an operational speed envelope of the shaft,
wherein the emergency ram air turbine generator deploys upon failure of one or more electrical generators on board an aircraft.

12. The aircraft of claim 11, wherein the composite material of the shaft is wound composite including a fiber count, a winding direction, a winding pitch, a thickness, and a diameter.

13. The aircraft of claim 12, wherein the shaft is hollow.

14. The aircraft of claim 12, wherein at least one of the fiber count, the winding direction, the winding pitch, the thickness, and the diameter is selected to achieve the tuned performance.

15. The aircraft of claim 14, wherein the shaft includes metal fittings at each end thereof.
